(19) United States
(12) Patent Application Publication
(10) Pub. No.: US 2016/0078689 A1
(43) Pub. Date: Mar. 17, 2016

(54) Systems and Methods for Valet Parking

(71) Applicant: Preston Christopher Cheng, Dallas, TX (US)

(72) Inventor: Preston Christopher Cheng, Dallas, TX (US)

(21) Appl. No.: 14/853,959

(22) Filed: Sep. 14, 2015

Related U.S. Application Data
(60) Provisional application No. 62/049,946, filed on Sep. 12, 2014.

(51) Int. Cl. G07B 15/02

(52) U.S. Cl. CPC G07B 15/02

(57) ABSTRACT

A system for coordinating valet services comprises a server including a server controller, a server database in communication with the controller, and server memory in communication with the controller, the server memory storing server program instructions that are executable by the controller. The system also includes a customer mobile device and a valet mobile device associated with a customer application and a valet application, respectively. The customer application is associated with a vehicle identifier, and the valet application is associated with a valet identifier. In response to receipt of the valet identifier and the vehicle identifier by the server from the customer application, the server controller prompts the valet application to request a ticket number.

### CROSS-REFERENCE TO RELATED APPLICATIONS

This application incorporates by reference and claims priority to U.S. Provisional Application Patent No. 62/049,946 filed Sep. 12, 2014.

### BACKGROUND OF THE INVENTION

The present subject matter relates generally to a system and method for coordinating valet parking. More specifically, the present invention relates to a series of software applications for customers and valets that allow customers to manage and pay for their valet-parked cars and allows the valets to streamline their procedures, monitor parking availability, receive automatic payments, make automatic payments, and manage the efficiency of their employees.

The valet service industry has much inefficiency. Currently there are no systems that allow valets to manage their parking lots based on customer live usage data so that they park cars, staff parking lots, and manage volume of traffic in their lots at optimum levels. Valets do not have any way of knowing how many cars are actively parked in their lot. This makes it difficult to allocate or assign employees to service cars. Valets also sometimes have issues locating vehicles that have been parked.

Another inefficiency in the valet service is payment for services. Valet payment methods are primarily based on cash, ticket systems, credit cards or cashiers. These methods involve slow processing times, and may inconvenience valet users who do not have cash on hand or are uneasy about using credit cards for security reasons. Also, customers often lose their valet stubs or tickets. Valets have limited ability to accept alternative forms of payment for services besides cash.

Related to this issue is the problem with accounting at a valet service. Currently, valet companies rely on the trust-worthiness of their valets to account for the amount of usage that has taken place on any day in any given lot. Valet companies must count the nightly intakes from the valet attendants and valet stands and then hire personnel to account for the revenue and pay out the attendants. Due to the limited valet payment options, valet companies do not have a means of identifying specific or extra tips that were dedicated to go to a specific valet attendant.

Although there are some software technologies designed to alleviate the inefficiencies of the valet industry, these solutions fall short in providing a comprehensive system for running valets and engaging valet services. Further, these technologies do not manage user data or account for user preferences.

Accordingly, there is a need for a valet service system that allows customers to engage and pay for valet services while enabling valet companies to manage their services, employees and accounting, as described herein.

### BRIEF SUMMARY OF THE INVENTION

To meet the needs described above and others, the present disclosure provides a valet service system that allows customers to engage and pay for valet services while enabling valet companies to manage their services, employees, and accounting.

By providing a system of mobile applications, websites and deposit accounts, the system and method allows valets to manage their business and efficiency and allows valet customers to pay for valets and ensure prompt service. The system includes a customer application that allows the customer to maintain a running tab of valet services and a paired valet application that is used to manage accounts, employees, funds, and reports. The system contemplates the presence of a system administrator for, among other things, coordinating payment details among users, responding to user requests, and synthesizing performance reports from the users' data.

In one example, a system for coordinating valet services includes: a server including: a server controller; a server database in communication with the controller, the server database including a plurality of unique identification codes, wherein each unique identification code is associated with one of a plurality of valet locations; and server memory in communication with the controller, the server memory storing server program instructions that are executable by the controller; a customer mobile device in communication with the server including: a customer controller; a customer user interface; and customer memory in communication with the customer controller, the customer memory storing customer application program instructions that are executable by the customer controller; and a valet mobile device in communication with the server including: a valet controller; a valet user interface; and valet memory in communication with the valet controller, the valet memory storing program instructions that are executable by the valet controller; wherein execution of the customer application program instructions by the customer controller provides a customer application through the customer user interface and execution of the valet application program instructions by the valet controller provides a valet application through the valet user interface; the customer application is associated with a vehicle identifier; the valet application is associated with a valet identifier in the server database, the valet identifier is also visually identifiable at a valet location; in response to receipt of the valet identifier and the vehicle identifier by the server from the customer application, the server controller prompts the valet application to request the vehicle identifier and a ticket number; in response to receipt of the vehicle identifier and a ticket number by the server from the valet application, the server controller stores a record in the database indicating the vehicle identifier status as checked in with the valet location; and in response to receipt of a notification request by the server from the customer application, the notification request including a vehicle identifier and a request for a valet attendant to retrieve the vehicle, the server prompts the valet application to provide a notification request alert through the valet user interface.

In some examples, the customer application includes a user interface for inputting the valet identifier and submitting the valet identifier to the server controller. In other examples, the customer application includes a user interface for displaying a map identifying the valet location, selecting the valet location associated with the valet identifier, and submitting the valet identifier to the server controller. The system may also include a user interface for displaying a list of a plurality of valet locations, selecting the valet location associated with the valet identifier, and submitting the valet identifier to the server controller.

In some embodiments, the server further includes a deposit account associated with the customer through which the customer transfers funds to the deposit account, and wherein funds are transferred from the deposit account to a valet account. In response to receipt of payment to the valet account, the server controller changes the vehicle identifier status to paid out.

In some examples, the valet application is programmed with natural language recognition user interfaces.

In yet other examples, the valet application includes a user interface for setting the valet cost based on a time of day. Further, the valet application may include a user interface for assigning a parking lot number to the ticket number. Additionally, the customer application may provide a location and contact information the valet location.

In an example of the methods of coordinating valet services taught herein, the method includes the steps of: providing a system comprising a controller and a database including a plurality of valet identifiers, wherein each valet identifier is associated with one of a plurality of valet locations; providing a plurality of valet devices, each including a valet application, in connection with a valet location; receiving, on each of the plurality of valet applications, a vehicle identifier from the controller in response to receipt of a valet identifier from a customer, wherein the valet identifier is associated with the valet location; and assigning, on at least one valet application, a ticket number to the vehicle identifier and storing the assignment in the database such that it is accessible by each of the valet applications.

The method may further includes the step of receiving, on each of the plurality of valet applications, a notification request alert from the controller in response to receipt of the notification request from the customer, wherein the notification request is associated with the valet location.

The server controller may store a record in the database indicating the vehicle identifier status as checked in. The method may further include the step of providing a checked in list of vehicles checked in and the step of receiving payment from the server.

In some examples of the method, the vehicle identifier status stored in the record in the database changes to paid out in response to receiving payment and the method further includes the step of providing a paid out list of vehicles for which payment has been received.

An object of the invention is to provide a solution to valet services that eliminates the need for cash transactions for the valet company and creates a seamless payment and confirmation process that both parties would accept.

Another object of the invention is to provide a solution to valet services that increases the productivity, accounting and collections capability, personnel count optimization, and increases operating leverage effectiveness of valet companies by using user data to boost parking performance of valet company parking attendants, accounting staff, company management and lot managers.

An advantage of the invention is that it provides a solution to valet services that stores payment information, thus reducing the per-swipe fees associated with credit cards and eliminating the need for cash or credit cards.

Another advantage of the invention is that it allows valet companies to manage their operations based on live data.

A further advantage of the invention is that it does not require exiting the application to launch SMS systems, nor does it rely on a third party website for payment transactions.

Yet another advantage of the invention is that it allows for users to be identified by their car that is registered with the application, and not by a scanned bar code that could potentially cause mistakes.

Another advantage of the invention is that it provides a field for entering validation codes when paying for valet services.

A further advantage of the invention is that it allows users to select tip options and identify who the tip should go to.

Additional objects, advantages and novel features of the examples will be set forth in part in the description which follows and the attached appendix, and in part will become apparent to those skilled in the art upon examination of the following description and the accompanying drawings or may be learned by production or operation of the examples. The objects and advantages of the concepts may be realized and attained by means of the methodologies, instrumentalities and combinations particularly pointed out in the appended claims.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 is a schematic representation of an embodiment of the system of the present invention.

FIG. 2 is a flow chart illustrating the steps of a method of operating the system of the present invention.

FIG. 3 is a user interface of the customer application for inputting a valet identifier.

FIG. 4 is a user interface of the customer application for submitting a notification request.

FIG. 5 is a user interface of the customer application for selecting a tip amount.

FIG. 6 is a user interface of the customer application for checking out.

FIG. 7 is a user interface of the customer application for submitting payment.

FIG. 8 is a user interface of the valet application for reviewing the checked in vehicles.

It should be noted that various changes and modifications to the presently preferred embodiments described herein will be apparent to those skilled in the art. Such changes and modifications may be made without departing from the spirit and scope of the present invention and without diminishing its attendant advantages.

### DETAILED DESCRIPTION

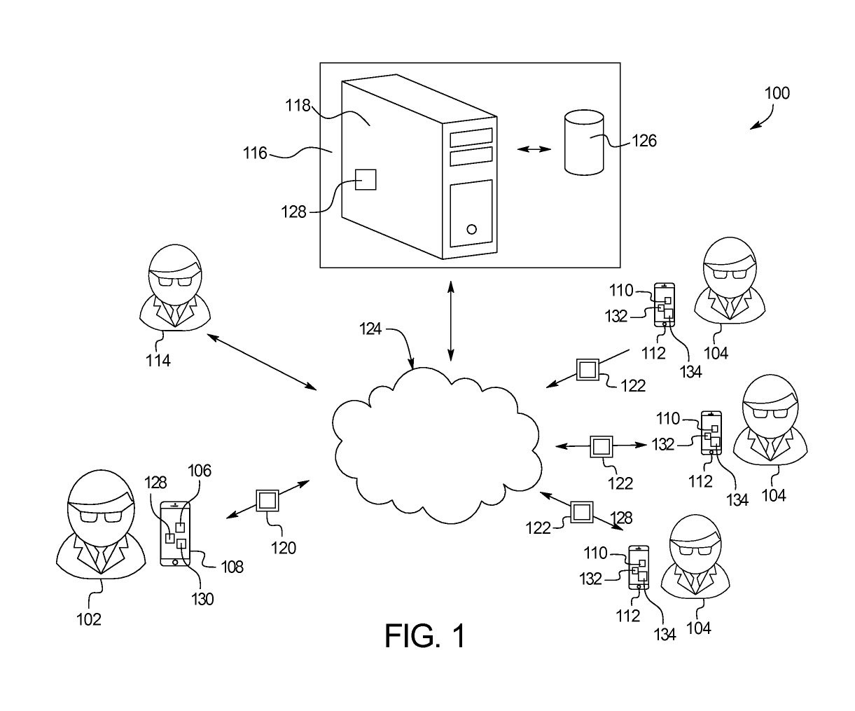

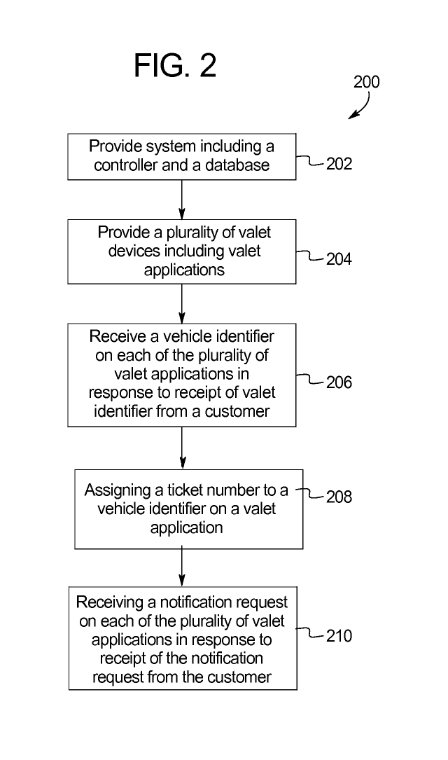

FIGS. 1 and 2 illustrate examples of the system 100 and method 200 for coordinating valet services between a customer 102 and a valet attendant 104. The customer 102 uses a customer application 106 on a customer mobile device 108 to communicate with the valet attendant 104, and the valet attendant 104 uses a valet application 110 on a valet mobile device 112 to communicate with the customer 102. In some embodiments, a system administrator 114 may coordinate the transfer of funds from the customer 102 to the valet attendant 104, respond to inquires from the customer 102 and the valet attendant 104, and provide performance reports based on customers' and valets' data. In other embodiments, the transfer of funds from the customer 102 to the valet attendant 104 is automated and the system administrator 114 provides oversight as necessary.

The system 100 may include a server 116 that facilitates communications between the customer mobile device 108 and the valet mobile device 112. The server 116 may include a controller 118 that receives communications 120, 122 from the customer and valet mobile devices 108, 112 over a network 124, such as the Internet. A server database 126 in communication with the controller 118 includes a plurality of valet identifiers, each of which is associated with a valet. The server 116 also includes a server memory 128 that stores server program instructions that are executable by the controller 118.

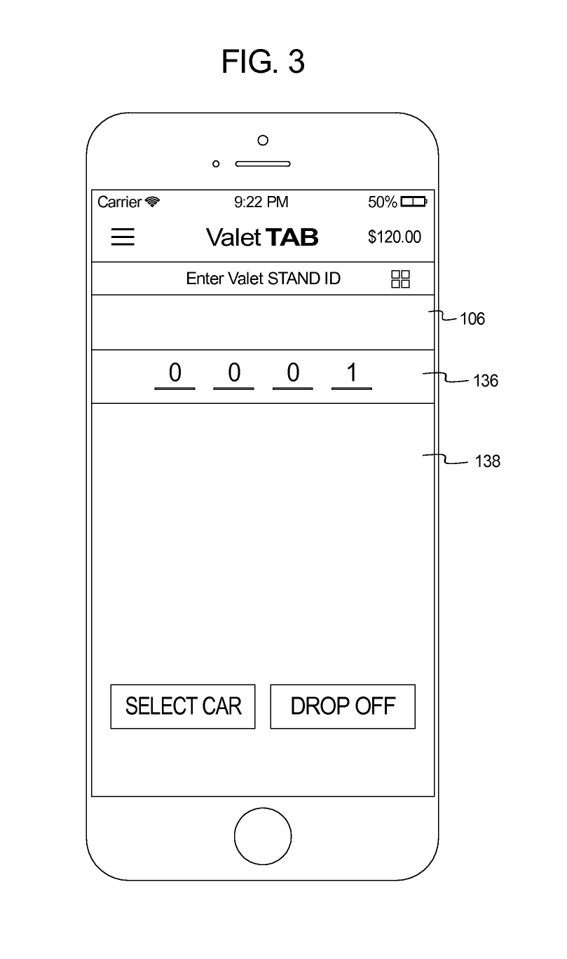

The customer mobile device 106 includes a customer controller 128 and a customer memory 130 that stores customer application program instructions that are executable by the customer controller 128. The customer mobile device 106 also includes a plurality of customer user interfaces illustrated in FIGS. 3-7. Execution of the customer application program instructions by the customer controller 128 provides the customer application 106 through the customer user interfaces. The system 100 may also include a customer website (not shown) through which the customer 102 may access his account information such as registration information as well as account history.

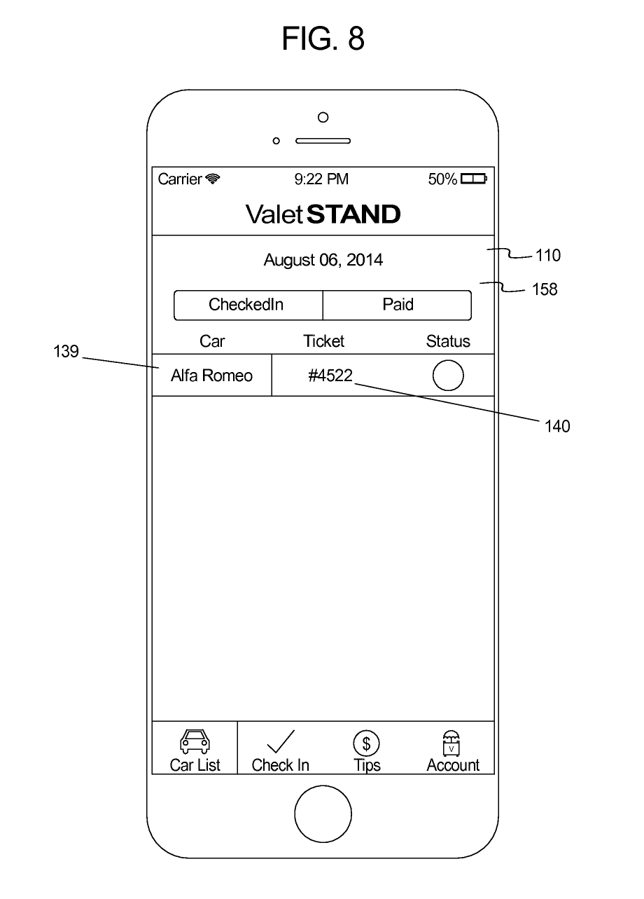

Similarly, the valet mobile device 112 includes a valet controller 132 and a valet memory 134 that stores valet application program instructions that are executable by the valet controller 132. The valet mobile device 112 provides a plurality of valet user interfaces as illustrated in FIG. 8. Execution of the valet application program instructions by the valet controller 132 provides the valet application 110 through the valet user interfaces. In one embodiment, the valet attendant 104 may set up more than one account from which it may receive payments through the customer application 106. The system 100 may also include a valet website through which the valet attendant 104 may access its account information such as registration information as well as account history. The valet application 110 may be adapted to receive inputs of various forms. For example, in some embodiments, the valet application 110 includes natural language recognition user interfaces that allow the valet attendant 104 to input and submit information to the server 116 using spoken commands.

The customer application 106 may require information during registration such as a name, an email address, a vehicle identifier such as a vehicle make, model, year, and color and/or a license plate number, and credit card information. The vehicle identifier may be associated with the customer application 106 so that when the customer submits information or requests to a valet, the vehicle identifier is provided as well. The customer may update this information as necessary.

The valet application 110 may require information during registration such as employee information (including names, driver's license numbers, years employed with the valet), insurance information, valet stand locations, lot capacities, parking spot locations, banking information, hours of operation, valet rates (which may vary by the hour of operation), valet stand contact information, number of employees assigned per valet stand, valet stand information (including business name, address, and phone number). The valet attendant 104 may update this information as necessary.

The valet application 110 is associated with one of the valet identifiers stored in the server database 126. The valet identifier may be visually identifiable at the valet stand. For example, the valet identifier may be a number, a name, a code, a QR code, etc. In another embodiment, the valet identifier may be displayed on a map through the customer application 106, where the map displays an area surrounding the customer's location and identifies valets within the area.

A plurality of valet applications 110 associated with a single valet location may be registered on a plurality of valet devices 112, each registered to the same valet location and used by different valet attendants 104. In another embodiment, the valet application 110 may be registered to a valet attendant 104 employed by two or more valets locations, where the valet attendant 104 has registered each valet location through the valet application 110.

When the customer 102 decides on the valet location to use, the customer 102 inputs the valet identifier 136 via a valet identifier user interface 138 of the customer application 106 as shown in FIG. 3, and submits the valet identifier 136 to the server 116. In other embodiments, the customer 102 may select a valet identifier 136 from a list of nearby valet locations, or may select a valet location on the map of the map user interface.

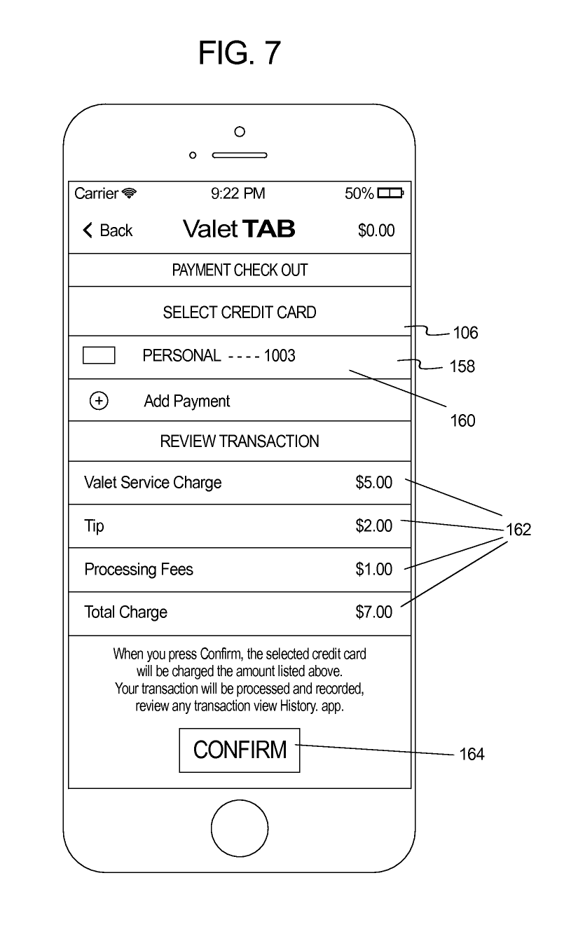

In response to the submission of the valet identifier 136, the server 116 prompts the one or more valet applications 110 associated with the valet identifier 136 to request the vehicle identifier 139 and a ticket number 140. The valet attendant 104 inputs a ticket number 140 for the vehicle identifier 139 through a user interface. The server controller 118 stores a record in the database 124 indicating the vehicle identifier 139 status as checked in with the valet attendant 104. The input of the ticket number 140 may lead to a user interface displaying a list of “checked in” vehicles including the vehicle identifier 139 as shown in FIG. 7.

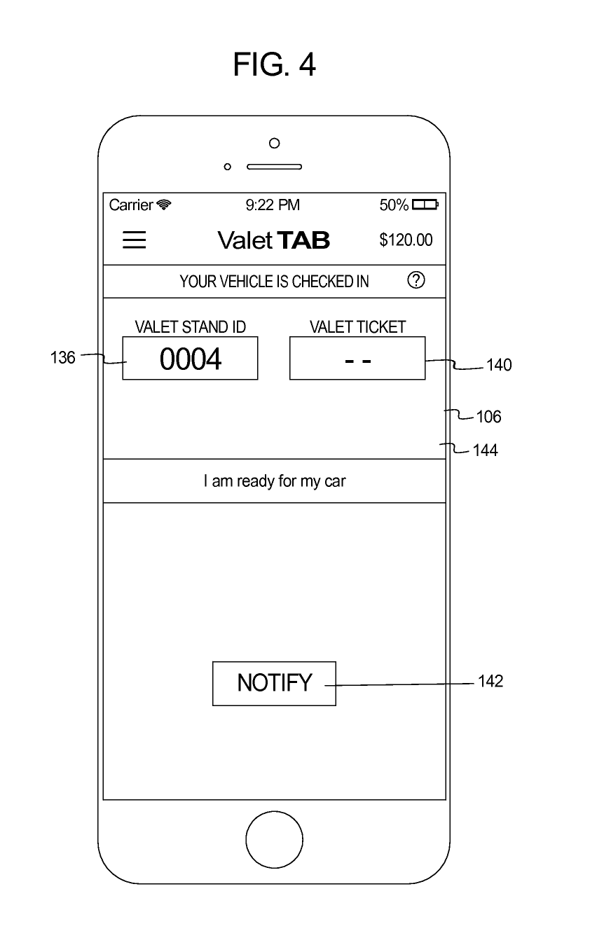

When the customer 102 is ready to pick up his car, he may submit a notification request 142 through the notification user interface 144 of the customer application 106 as shown in FIG. 4 to the server 116. Alternatively, he may submit the notification request 142 through the customer application 106 using a short message service (SMS) For example, in case the customer 102 is in an area with poor cellular data reception, the customer application 106 may notify the customer 102 via an SMS based text message, allowing another communication path for two-way communication between the valet attendant 104 and the customer 102. The notification request 142 includes the vehicle identifier 139 and a request 146 for the valet attendant 104 to retrieve the vehicle. The notification user interface 142 through which the customer 102 submits the notification request 142 may include one or more timing options to indicate when the customer 102 will be ready to pick up the car. For example, the timing options may include options for picking the vehicle up now, in five minutes, or in ten minutes. In response, the server 116 prompts the valet application 110 to provide a notification request alert through the valet user interface. In some embodiments, the notification request 142 includes an option to pay an additional fee to place the car at the top of the retrieval queue.

If the car has been retrieved and is ready for the customer 102 and the customer 102 is not ready, the valet attendant 104 may send a push notification to let the customer 102 know that the car is waiting.

In one example embodiment, the method 200 of coordinating valet services is illustrated in FIG. 2. In the first step 202, a system 100 is provided comprising a controller 118 and a database 126 including a plurality of valet identifiers 136, wherein each valet identifier 136 is associated with one of a plurality of valets locations. In the second step 204, a plurality of valet devices 112, each including a valet application 110 associated with a valet location and/or valet attendant 104 is provided. In the third step 206, each of the plurality of valet applications 110 receives the vehicle identifier 139 from the controller 118 in response to receipt of the valet identifier 136 from a customer 102, wherein the valet identifier 136 is associated with the valet location. In the fourth step 208, a ticket number is assigned to the vehicle identifier 139 on at least one valet application 110. The assignment is stored in the database 126 such that it is accessible by each of the valet applications 110. In a fifth step 210, each of the plurality of valet applications 110 receives a notification request alert from the controller 118 in response to receipt of the notification request from the customer 102, wherein the notification request is associated with the valet location and/or valet attendant 104.

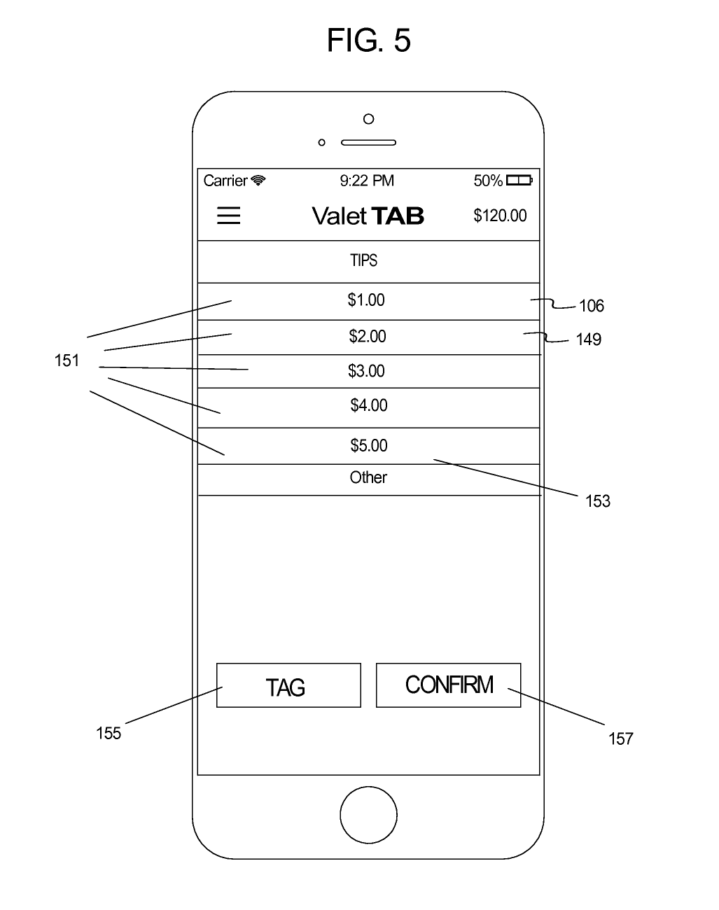

In a preferred example, the customer application 106 is also configured to provide a series of user interfaces for making a payment. The tip user interface 149 shown in FIG. 5 includes the option 151 of selecting a tip of $1, $2, $3, $4, $5, or the ability to enter a specific amount by selecting the “other” option 153. In the illustrated embodiment, a tag option 155 allows the customer to identify a valet attendant 104 for the tip to be paid directly to the attendant's account. Once the tip is selected, the customer 102 selects the confirmation option 157, which leads to the check out user interface 148.

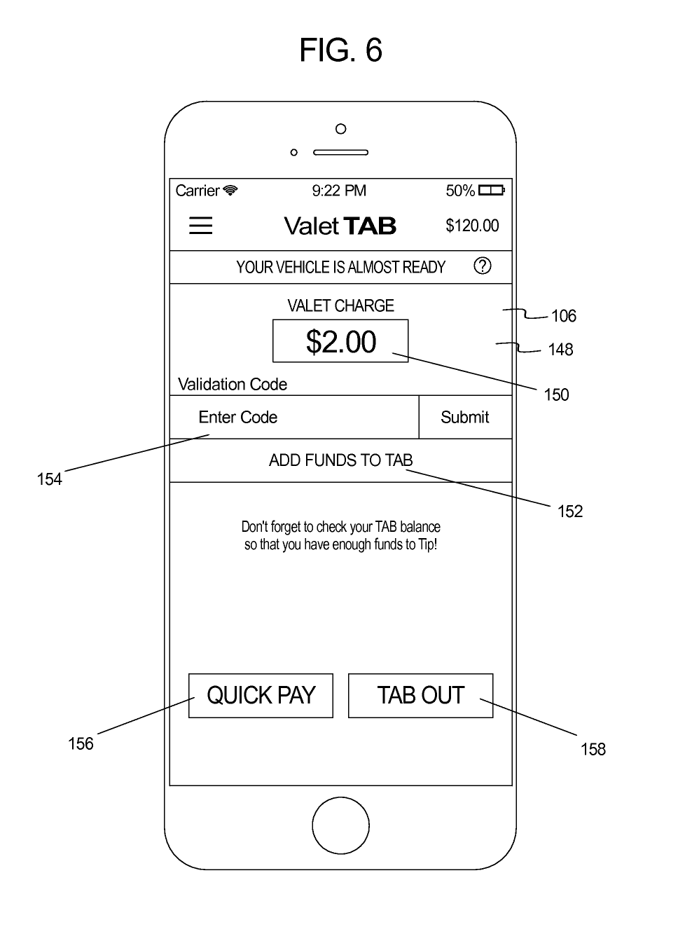

The check out user interface 148 as illustrated in FIG. 6 allows the customer 102 to view the tip amount 150, and provides an option 152 to add funds to the deposit account, an option 154 to enter a validation code, an option 156 to pay directly from a credit card, and an option 158 to pay out of the deposit account. The validation code option 154 acts as a coupon and results in the reduction of the valet cost. Selection of the pay option 156 leads to a payment user interface 158 shown in FIG. 7 that identifies the selection 160 of credit card, presents a summary 162 of the transaction, including the valet service charge, the tip amount, and the total charge, and allows for confirmation 164 of payment. In other embodiments, the system administrator 114 reviews outgoing payments at the end of each day and notifies the valets attendants 104 of the amounts of funds to be transferred.

The customer application 106 may also include a valet locator user interface, wherein the customer 102 may view the location, either an address or a GPS location, a phone number, an email address, or any other contact information of the valet location where the car was checked in. In one example, the customer 102 may forget with which valet location he had left his car, and can use the valet location user interface to find his car.

After the customer 102 has received his car and pays the valet attendant 104, the valet attendant 104 moves the vehicle identifier 139 into the “paid out” list by changing the vehicle identifier status to paid out. The vehicle identifier status may be stored in the server database 126 such that the status is accessible from any of the associated applications, including both the valet applications 110 and the customer applications 106. The customer 102 may rank the valet experience through the customer application 106 after the payment obligations of have been satisfied. Similarly, the customer application 106 may be adapted such that the associated restaurants, hotels, stadiums, bars, nightclubs, parks, and any other venues associated with the valet experience may receive feedback in the form of stars or a numeric rating on metrics related to the establishments.

The server 116 may also maintain a payment system to allow the customer 102 to transfer funds to the valet attendant 104 through the customer applications 106 and valet applications 110. Specifically the server 116 may include a deposit account that stores funds for the customer 102. The customer 102 authorizes loading of the deposit account using the credit card information provided during registration or may be prompted to provide other credit card information. The customer 102 selects the amount to be loaded to the deposit account, and the customer application 106 charges the card in the selected amount and transfer the funds to the deposit account on the server 116. Alternatively, the customer application 106 may include the option to charge the customer's credit card directly, rather than drawing funds from the deposit account. The customer 102 may view the balance and the history of deposits through the customer application 106 or through the customer website.

The valet application 110 may also provide services related to management of the business such as tagging tip receipts, distributing pay at the end of the night, and coordinating schedules, and shift times. The valet attendant 104 may select the cost for valet parking at any given time. For example, the cost may be $10, $15, and $20 if the car is parked between noon and 3 pm, between 3 pm and 7 pm, and between 7 pm and 10 pm, respectively. The valet application 110 may also allow the valet attendant 104 to implement surge pricing, i.e. raise the cost based on limited availability of spots or number of valet requests received in a given amount of time. The valet application 110 may be used to manage shifts and allow valet attendants 104 to check and clock out, and to manage the tips of employees that are checked into the application 110.

Further, the valet website may connect to the valet application 110 to funnel updates and management-based decisions through to the website, allowing complete control for the valet operators even from remote locations. Valet operators may also review the performance of stands, including data about profit, number of customers 102 checked in with the application, and the number of turns the lot is making in any given shift or on any given day. The valet owner may also have access to summary reports with data and analysis regarding the performance and operation of the stand according to various metrics, including number of cars, types of cars, turnaround time on a parking space, employee timeliness, time it takes to pull out a car from point of notification, revenue earned through the application, tips earned through the valet application 110, number of customers 102 who used the app for their valet services, and number of customers 102 using validation codes.

Using the website, the valet owner may manage schedules of valet attendants 104 by inputting the desired location, time and date of their valet attendants 104. The valet attendants 104 may then receive emails through the website or notifications through their valet applications 110 notifying them about where they are needed most. Valet owners may be able to monitor the check in and check out times of valet attendants 104. The valet owner may also review payout history.

As noted above, the system 100 may collect and store various data in the server database 126. The controller 128 may provide additional functionality using such data. For example, for lot management purposes, usage data may be aggregated to calculate the best places for cars to be parked in a given lot. For example, cars that traditionally stay longer may be parked further away from the valets location while cars that stay for short periods of time may be parked closer. Based on past usage patterns, the valet application 110 may provide notice to the valet attendants 104 of where to park a vehicle when the vehicle checks in with the valet attendants 104. This feature may be made even more useful when parking site surveys are incorporated into the valet application 110 and/or the database 126. In such cases, the valet application 110 may indicate to the valet attendants 104 where to park the vehicle down to the specific parking space.

Similarly, usage data and status data may be used to provide VIP status indications for select customers 102 so valets attendants 104 can serve them accordingly. For example, such information may enable the valets attendants 104 to notify a restaurant when a VIP customer 102 has arrived and may enable VIP customers 102 to park in exclusive front-of-location, easy-access parking spots. Although there are many ways in which customers 102 may be identified as VIPs, there may be a points system that rewards points based on usage of the customer application 106 and the frequency of checking in to VIP partner locations (e.g., a social media check-in to a partner restaurant).

Relatedly, the system 100 may allow restaurants, hotels, stadiums, bars, nightclubs, parks, or any other entertainment venue to have a unique check-in screen, that offers promotions to customers 102 based factors such as the number of times a customer 102 has checked-in or other criteria.

Map and location views of valet locations may be incorporated into the user experience such that the customer application 106 shows customers 102 the location of the valet and the price that is currently being charged. These features may use GPS on the customer mobile device 108 to locate the nearby valet locations and may present the customer 102 with the nearby locations based on their GPS location. GPS location identification may be an alternative to the process described above in which the customer 102 checks-in to the desired valet location without using the valet identifier 136.

Additional GPS services may be provided to assist less able-bodied customers 102 to find appropriate services. GPS mapping features may also allow for comparison pricing so that the customers 102 may obtain the best price. In addition, the customer application 106 may use GPS information to assist the customer 102 in remembering where the car is parked and provide the user a number to call the valet location if needed.

Dispute resolution services may be provided via the system 100. For example, in the event that there is damage to a vehicle the customer application 106 and/or the valet application 110 may allow users to take pictures of the incident, take down the name of the driver, and submit the case back to the valet location administrator account for review. Through the system 100, the valet location administrator may be able to submit materials to insurance or resolve the claim on its own. The administrator may further be able to reach out to the owner of the damaged vehicle through whatever notes are recorded at the scene.

Although the uses described herein are directed towards the valet service industry, the features and functionalities of the system may apply across industries and services. For example, the deposit system may be used to cut down on transaction costs in any industry or company that wishes to maintain customer balances.

It should be noted that various changes and modifications to the embodiments described herein will be apparent to those skilled in the art. Such changes and modifications may be made without departing from the spirit and scope of the present invention and without diminishing its attendant advantages. For example, various embodiments of the systems and methods may be provided based on various combinations of the features and functions from the subject matter provided herein.

I claim:

1. A system for coordinating valet services comprising:
a server including:
a server controller;
a server database in communication with the controller, the server database including a plurality of unique identification codes, wherein each unique identification code is associated with one of a plurality of valet locations; and
server memory in communication with the controller, the server memory storing server program instructions that are executable by the controller;
a customer mobile device in communication with the server including:
a customer controller;
a customer user interface; and
customer memory in communication with the customer controller, the customer memory storing customer application program instructions that are executable by the customer controller; and
a valet mobile device in communication with the server including:
a valet controller;
a valet user interface; and
valet memory in communication with the valet controller, the valet memory storing program instructions that are executable by the valet controller;
wherein execution of the customer application program instructions by the customer controller provides a customer application through the customer user interface and execution of the valet application program instructions by the valet controller provides a valet application through the valet user interface;
the customer application is associated with a vehicle identifier;
the valet application is associated with a valet identifier in the server database, the valet identifier is also visually identifiable at a valet location;
in response to receipt of the valet identifier and the vehicle identifier by the server from the customer application, the server controller prompts the valet application to request the vehicle identifier and a ticket number;
in response to receipt of the vehicle identifier and a ticket number by the server from the valet application, the server controller stores a record in the database indicating the vehicle identifier status as checked in with the valet location; and
in response to receipt of a notification request by the server from the customer application, the notification request including a vehicle identifier and a request for a valet attendant to retrieve the vehicle, the server prompts the valet application to provide a notification request alert through the valet user interface.

2. The system of claim 1, wherein the customer application includes a user interface for inputting the valet identifier and submitting the valet identifier to the server controller.

3. The system of claim 1, wherein the customer application includes a user interface for displaying a map identifying the valet location, selecting the valet location associated with the valet identifier, and submitting the valet identifier to the server controller.

4. The system of claim 1, wherein the customer application includes a user interface for displaying a list of a plurality of valet locations, selecting the valet location associated with the valet identifier, and submitting the valet identifier to the server controller.

5. The system of claim 1, wherein the server further includes a deposit account associated with the customer.

6. The system of claim 5, wherein the customer transfers funds to the deposit account, and wherein funds are transferred from the deposit account to a valet account.

7. The system of claim 6, wherein in response to receipt of payment to the valet account, the server controller changes the vehicle identifier status to paid out.

8. The system of claim 1, wherein the valet application is programmed with natural language recognition user interfaces.

9. The system of claim 1, wherein the valet application includes a user interface for setting the valet cost based on a time of day.

10. The system of claim 1, wherein the valet application includes a user interface for assigning a parking lot number to the ticket number.

11. The system of claim 1, wherein the customer application provides a location and contact information the valet location.

12. A method of coordinating valet services comprising the steps of:
providing a system comprising a controller and a database including a plurality of valet identifiers, wherein each valet identifier is associated with one of a plurality of valet locations;
providing a plurality of valet devices, each including a valet application, in connection with a valet location;
receiving, on each of the plurality of valet applications, a vehicle identifier from the controller in response to receipt of a valet identifier from a customer, wherein the valet identifier is associated with the valet location; and
assigning, on at least one valet application, a ticket number to the vehicle identifier and storing the assignment in the database such that it is accessible by each of the valet applications.

13. The method of claim 12, further comprising the step of receiving, on each of the plurality of valet applications, a notification request alert from the controller in response to receipt of the notification request from the customer, wherein the notification request is associated with the valet location.

14. The method of claim 12, wherein the server controller stores a record in the database indicating the vehicle identifier status as checked in.

15. The method of claim 14, further comprising the step of providing a checked in list of vehicles checked in.

16. The method of claim 15, further comprising the step of receiving payment from the server.

17. The method of claim 16, wherein the vehicle identifier status stored in the record in the database changes to paid out in response to receiving payment.

18. The method of claim 17, further comprising the step of providing a paid out list of vehicles for which payment has been received.
